(19) United States
(12) Patent Application Publication
(10) Pub. No.: US 2014/0331147 A1
(43) Pub. Date: Nov. 6, 2014

(54) AUTOMATIC USER-BASED CONFIGURATION OF OPERATING SYSTEM SHELL

(71) Applicants: Shailesh Jain, Bangalore (IN); Shashidhar Banavasi Sadanand, Bangalore (IN)

(72) Inventors: Shailesh Jain, Bangalore (IN); Shashidhar Banavasi Sadanand, Bangalore (IN)

(21) Appl. No.: 14/020,373

(22) Filed: Sep. 6, 2013

(30) Foreign Application Priority Data
May 1, 2013 (IN) 1964/CHE/2013

(51) Int. Cl. G06F 3/0484

(52) U.S. Cl. CPC G06F 3/0484
USPC 715/745

(57) ABSTRACT

In one embodiment, a method performed by a computing device includes receiving one or more command-line options; determining a user associated with the computing device; accessing, based on the command-line options and the user, configuration file for configuration settings for one or more user interfaces with the operating system shell hosted by the computing device; and creating the user interfaces within the operating system shell based on the configuration settings.

### PRIORITY

This application claims the benefit of priority under 35 U.S.C. §119(a) of Indian Patent Application No. 1964/CHE/2013, filed on 1 May 2013, the entirety of which is incorporated herein by reference.

### TECHNICAL FIELD

This disclosure generally relates to user interfaces and, in particular, relates to automatic configuration of a user interface to an operating system.

### BACKGROUND

As the value and use of information continues to increase, individuals and businesses seek additional ways to process and store information. One option available to these users is an information handling system or computing system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

The information handling system may include one or more operating systems. An operating system serves many functions, such as controlling access to hardware resources and controlling the execution of application software. Operating systems also provide resources and services to support application software. These resources and services may include a file system, a centralized configuration database (such as the registry found in Microsoft Windows operating systems), a directory service, a graphical user interface, a networking stack, device drivers, and device management software. In some instances, services may be provided by other application software running on the information handling system, such as a database server.

Some information handling systems are designed to interact with other information handling systems over a network connection. In some instances, the information handling systems may share resources over the network. Certain of the networked information handling systems may act as servers, while others act as clients. In such systems, client applications and client devices may be designed so that the majority of the heavily used resources are at a shared information handling system, such as a centralized server. The client devices may have minimal memory, disk storage, and processor power. Use of such client devices may reduce the total cost of ownership because of the reduced use of resources at the client devices and because the clients can be centrally administered and updated from the server. Such client devices may be particularly well-suited for a network which can handle a significant number of devices.

### BRIEF DESCRIPTION OF THE DRAWINGS

FIG. 1 illustrates an example configuration of networked information handling systems.

FIG. 2 illustrates a graphical representation of an Extensible Markup Language (XML) Schema Definition (XSD) file.

FIG. 3 illustrates a graphical representation of an example XML definition for users.

FIG. 4 illustrates a graphical representation of an example XML definition for user options.

FIG. 5 illustrates a graphical representation of an example XML definition for desktop shortcuts configuration.

FIG. 6 illustrates a graphical representation of an example XML definition for Start Menu Toolbar configuration.

FIG. 7 illustrates an example Start Menu Toolbar.

FIG. 8 illustrates an example Start Screen user interface.

FIG. 9 illustrates a graphical representation of an example Start Screen XML configuration.

FIG. 10 illustrates an example method for creating a standard configuration.

FIG. 11 illustrates an example method for creating a custom configuration.

FIG. 12 illustrates an example method for configuring a client device.

FIG. 13 illustrates another example method for configuring a client device.

FIGS. 14A and 14B illustrate an example flow chart of a configuration application.

FIG. 15 illustrates an example computing system.

### DESCRIPTION OF EXAMPLE EMBODIMENTS

This disclosure generally relates to user interfaces and, in particular, relates to automatic configuration of a user interface to an operating system.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

For the purposes of this disclosure, computer-readable storage media may include any instrumentality or aggregation of instrumentalities that may retain data and/or instructions for a period of time. Computer-readable storage media may include, for example without limitation, storage media such as a direct access storage device (e.g., a hard disk drive or floppy disk), a sequential access storage device (e.g., a tape disk drive), compact disk, CD-ROM, DVD, RAM, ROM, electrically erasable programmable read-only memory (EEPROM), and/or flash memory.

As used herein, a “local” device of a system, or a device “locally” connected to a system, may be a device directly connected to the system using one or more wires or connectors (e.g., physically connected to the system), a device indirectly connected to the system using one or more hubs, or a device directly connected to the system using a wireless link. Furthermore, in one aspect of the present disclosure, a local device of a system or a device locally connected to a system may include a device within the system (e.g., an internal device).

The present disclosure is now described in detail with reference to a few embodiments thereof as illustrated in the accompanying drawings. In the following description, numerous specific details are set forth in order to provide a thorough understanding of the present disclosure. However, the present disclosure may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

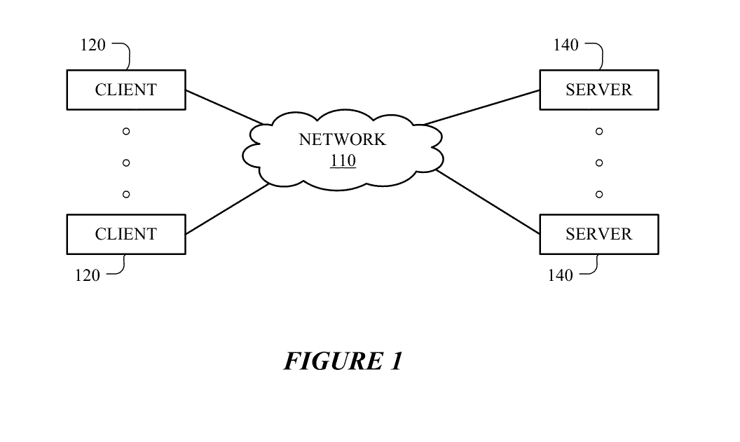

FIG. 1 illustrates an example configuration of networked information handling systems. In particular embodiments, one or more client devices 120 and one or more servers 140 are connected via network 110. A client device 120 may be a desktop computer, a laptop computer, a tablet computer, a thin client, a handheld device, a cell phone, or any suitable information handling system. A client device 120 may communicate with a server 140 via one or more protocols such as Hypertext Transfer Protocol (HTTP), Independent Computing Architecture (ICA) protocol developed by Cytrix Systems, Inc. in Fort Lauderdale, Fla., Remote Desktop Protocol (RDP) developed by Microsoft Corporation in Redmond, Wash., or any suitable protocols. A client device 120 may access resources provided by a server 140 such as data, applications, or printers. A server 140 may be a server computing device, a desktop computer, a laptop computer, or any suitable information handling system. In one embodiment, a server 140 may be a virtual machine, a remote desktop session, or any suitable application running on one or more information handling systems.

An organization (e.g., a business, a hospital, or a library) may deploy multiple client devices throughout the organization. Those client devices may access servers of the organization for resources such as printers or applications (e.g., email, database, and so on). The organization (e.g., an engineer of the organization's information technology or IT department) may centrally manage those client devices by applying configurations and provisioning to the client devices, while monitoring states of the client devices (e.g., whether a deployed client device is up-and-running or non-responsive).

Configuring a client device such as a thin client may comprise creating an image (e.g., a copy) of an operating system (OS) and customization of the OS image. The OS image may also include one or more applications, and interfaces for accessing the applications in a user interface of the operating system or an operating system shell. However, different user interface designs of different operating systems may pose challenges in creating a consistent interface for accessing an application in OS images of different operating systems.

For example, a user interface of the operating system Windows 7 developed by Microsoft (or previous versions of Microsoft operating systems such as Windows XP) may include a Start Menu user interface that allows a user to access any available applications. However, the Start Menu user interface is not readily available in the user interface of Microsoft's Windows 8 operating system. With Windows 8, a Start Screen user interface comprising multiple tiles provides access to applications. A tile in the Start Screen user interface represents a short-cut to an application, while a user may select a tile to access a corresponding application. The Start Screen may also include one or more tile groups. Each of the tile groups includes tiles corresponding to a set of applications.

However, not every installed application on a client device has a corresponding tile in the Start Screen user interface initially provided by Microsoft. A user may need manually add a tile of an application to the Start Screen user interface. Similarly, a user may need to manually select a set of applications to form a tile group. This poses challenges in creating OS images for multiple client devices, as a provider of the OS images may need to manual create tiles (or tile groups) for each OS image.

In addition, the Start Screen user interface may differ between users based on user privilege settings. A provider of OS images may have automated procedure that performs customization for the Start Screen user interface once a new user logs into the system. The customization may happen only once when the user logs in for a first time. However, an image cloning tool (e.g., Microsoft's System Preparation Tool SYSPREP) may remove the customization in tiles and tile groups in the Start Screen user interface.

Meanwhile, it may be desirable to add the Start Menu user interface to a user interface of Windows 8 such that a user may have an easier transition from the user interface of Windows 7 (or previous versions of Microsoft Windows operating systems such as Windows XP) to the user interface of Windows 8. The addition of the Start Menu to a user interface of Windows 8 may differ between users based on user settings.

Additional customizations may be applied to the user-based Start Screen customization described earlier. For example, a vendor of thin clients (e.g., Dell Wyse in San Jose, Calif.) may perform certain Start Screen configurations to create Standard Builds for thin clients that are ready to be shipped to customers. After receiving thin clients from the vendor, a customer may perform more customizations on top of the Standard Builds to accommodate its own needs. For example, the customer may create its own set of tiles and tile groups for the Start Screen user interface based on different types of users before deploying the thin clients to end users.

In addition, the customer may perform user-based customization for the Start Menu user interface (in Windows 8's user interface) based on different types of users.

The customer may also create a custom configuration and deploy the custom configuration to multiple thin clients. Instead of manually creating a custom configuration for each of the thin client, it is desirable to use a remote management technique for the deployment.

Particular embodiments implement methods for automatically, without manual input, configuring the Start Screen user interface, the Start Menu Toolbar user interface, and a Desktop Shortcuts user interface in a Windows 8 user interface based on different users. Particular embodiments may apply the configuration when a user logs in to a client device for a first time, while the configuration may persist for subsequent user logins. For example, a vendor of thin client (e.g., Dell Wyse) may include such a configuration as a standard configuration (of the Standard Builds described above) for thin clients that are ready to be shipped to customers. Particular embodiments may also create user profiles that are part of thin clients that are ready to be shipped to customers.

After receiving thin clients from the vendor, a customer may create and deploy custom configuration for the Start Screen user interface, the Start Menu Toolbar user interface, or the Desktop Shortcuts user interface based on different users. Particular embodiments may also enable customers or end users to create their own user profiles that are different from the user profile shipped with the thin clients from the vendor.

Particular embodiments may maintain two types of configurations such as the standard configuration and the custom configuration as described above. The standard configuration may serve as a back-up for the custom configuration. For example, if the custom configuration is non-responsive, a user may rollback to the standard configuration that is shipped with the user's thin client.

Particular embodiments may maintain different user profiles for local and domain users. For example, different profiles may be applied to a user depending on whether the same user logs in as a local user or as a domain user.

Particular embodiments may enable localization support for the Start Screen user interface and the Start Menu Toolbar user interface in both standard configuration and custom configuration.

Particular embodiments may enforce access privilege settings. For example, a non-administrator user may not access a user profile of an administrator user, and vice versa.

Particular embodiments may automatically configure a Start Screen user interface, a Start Menu Toolbar user interface, and a Desktop Shortcuts user interface in any suitable version of Windows 8 (e.g., Windows Embedded 8 Standard, Windows 8, Windows 8 Pro, Windows 8 Enterprise, or Windows RT).

Particular embodiments may create, without manual input, configuration of the Start Screen user interface (i.e., configuring of tiles and tile groups in the Start Screen user interface) based on different users by using a configuration application that is executed every time when a user logs into a client device for the first time. One or more processors of the client device may execute the configuration application based on a configuration file. The configuration file may be stored in local storage of the client device. The client device may also access a remote server to obtain the configuration file. For illustrative purposes, the configuration application may be a command line application WSC.exe. For illustrative purposes, the configuration file may be an Extensible Markup Language (XML) configuration file WSCConfig.xml.

In particular embodiments, the Start Menu Toolbar user interface in a Windows 8 user interface may provide access to applications in a way similar to what the Start Menu user interface provide in a Window 7 user interface. Particular embodiments may configure the Start Menu user interface based on different users. Particular embodiments may add or remove one or more items in the Start Menu Toolbar user interface for a user based on the configuration file. Particular embodiments may configure the Start Menu user interface by executing the configuration application (e.g., WSC.exe).

A user may configure (e.g., for the user's needs) the Start Screen user interface, the Start Menu Toolbar user interface, and the Desktop Shortcuts user interface in a Windows 8 user interface. Particular embodiments may create a user profile for the user's custom configuration by executing the configuration application to capture (i.e., save) the user's custom configuration while the user logs in the client device. The user profile may be used for the user's subsequent logins at the client device. Furthermore, particular embodiments may copy a first user's user profile to a second user's user profile. For example, a first user <user1> currently logs into the client device. Executing the configuration application WSC.exe -cp <user2> may create a same user profile of the first user <user1> for a second user <user2>. Particular embodiments may apply the user profile to the second user when the next time the second user logs into the client device.

Once the custom configuration described above is created, particular embodiments may deploy the custom configuration to multiple thin clients. Particular embodiments may automatically deploy the custom configuration using remote management tools such as Dell Wyse Configuration Manager (WCM) or Dell Wyse Device Manager (WDM).

For illustrative purposes, codes of an example XML configuration file are listed below.

| | |
|---|---|
| <?xml version=“1.0” encoding=“utf-8”?> | |
| <ShellCustomisations> | |
| <Users> | |
| <Admin> | |
| <Desktop Shortcutpath | = |
| “C:\Windows\setup\Profile\Standard\Users\Admin\Desktop”> | |
| </Desktop> | |
| <StartMenuToolbar StartMenuRegFilePath | = |
| “C:\Windows\setup\Profile\Standard\Users\Admin\StartMenu\ | |
| RegFile\startmenu.reg”> | |
| <AddLinks Shortcutpath | = |
| “C:\Windows\setup\Profile\Standard\Users\Admin\StartMenu\Layout”> | |
| <Link name = “Power” StartMenuProgramsFolder = “” /> | |
| <Link name = “Search.lnk” StartMenuProgramsFolder = “” /> | |
| </AddLinks> | |
| <RemoveLinks> | |
| <Link name = “Programs\Accessories\Wordpad.lnk” /> | |
| <Link name = “Programs\System Tools\Windows | |
| PowerShell.lnk” /> | |
| </RemoveLinks> | |
| </StartMenuToolbar> | |
| <StartScreen LayoutPath | = |
| “C:\Windows\setup\Profile\Standard\Users\Admin\StartScreen” | |
| ShortcutPath | = |
| “C:\Windows\setup\Profile\Standard\Users\Admin\StartScreen”> | |
| </StartScreen> | |
| </Admin> | |
| <User> | |
| <Desktop Shortcutpath | = |
| “C:\Windows\setup\Profile\Standard\Users\User\Desktop”> | |
| </Desktop> | |
| <StartMenuToolbar StartMenuRegFilePath | = |
| “C:\Windows\setup\Profile\Standard\Users\User\StartMenu\RegFile\ | |
| startmenu.reg”> | |
| <AddLinks Shortcutpath | = |
| “C:\Windows\setup\Profile\Standard\Users\User\StartMenu\Layout”> | |
| <Link name = “Power” StartMenuProgramsFolder = “” /> | |
| <Link name = “Calculator.lnk” StartMenuProgramsFolder | = |
| “\Programs\Accessories” /> | |
| </AddLinks> | |
| <RemoveLinks> | |
| <Link name = “programs\System Tools\Command | |
| Prompt.lnk” /> | |
| </RemoveLinks> | |
| </StartMenuToolbar> | |
| <StartScreen LayoutPath | = |
| “C:\Windows\setup\Profile\Standard\Users\User\StartScreen” | |
| ShortcutPath | = |
| “C:\Windows\setup\Profile\Standard\Users\User\StartScreen”> | |
| </StartScreen> | |
| </User> | |
| <Default> | |
| <Desktop Shortcutpath | = |
| “C:\Windows\setup\Profile\Standard\Users\Default\Desktop”> | |
| </Desktop> | |
| <StartMenuToolbar StartMenuRegFilePath | = |
| “C:\Windows\setup\Profile\Standard\Users\Default\StartMenu\RegFile\ | |
| startmenu.reg”> | |
| <AddLinks Shortcutpath | = |
| “C:\Windows\setup\Profile\Standard\Users\Default\StartMenu\Layout”> | |
| <Link name = “Power” StartMenuProgramsFolder = “” /> | |
| <Link name = “Calculator.lnk” StartMenuProgramsFolder | = |
| “\Programs\Accessories” /> | |
| </AddLinks> | |
| </StartMenuToolbar> | |
| <StartScreen LayoutPath | = |
| “C:\Windows\setup\Profile\Standard\Users\Default\StartScreen” | |
| ShortcutPath | = |
| “C:\Windows\setup\Profile\Standard\Users\Default\StartScreen”> | |
| </StartScreen> | |
| </Default> | |
| </Users> | |
| </ShellCustomisations> | |

For illustrative purposes, codes of an example XML Schema Definition (XSD) file associated with the example XML configuration file above is listed below.

```
<?xml version=“1.0” encoding=“utf-8”?>
<xs:schema attributeFormDefault=“unqualified”
elementFormDefault=“qualified”
xmlns:xs=“http://www.w3.org/2001/XMLSchema”>
  <xs:element name=“ShellCustomisations”>
    <xs:complexType>
      <xs:sequence>
        <xs:element name=“Users”>
          <xs:complexType>
            <xs:sequence>
              <xs:element name=“Admin”>
                <xs:complexType>
                  <xs:sequence>
                    <xs:element name=“Desktop”>
                      <xs:complexType>
                        <xs:simpleContent>
                          <xs:extension base=“xs:string”>
                            <xs:attribute name=“Shortcutpath”
type=“xs:string” use=“required” />
                          </xs:extension>
                        </xs:simpleContent>
                      </xs:complexType>
                    </xs:element>
                    <xs:element name=“StartMenuToolbar”>
                      <xs:complexType>
                        <xs:sequence>
                          <xs:element name=“AddLinks”>
                            <xs:complexType>
                              <xs:sequence>
                                <xs:element maxOccurs=
                                “unbounded”
name=“Link”>
                                  <xs:complexType>
                                    <xs:attribute name=“name”
type=“xs:string” use=“required” />
                                    <xs:attribute
name=“StartMenuProgramsFolder” type=“xs:string” use=“required” />
                                  </xs:complexType>
                                </xs:element>
                              </xs:sequence>
                              <xs:attribute name=“Shortcutpath”
type=“xs:string” use=“required” />
                            </xs:complexType>
                          </xs:element>
                          <xs:element name=“RemoveLinks”>
                            <xs:complexType>
                              <xs:sequence>
                                <xs:element maxOccurs=
                                “unbounded”
name=“Link”>
                                  <xs:complexType>
                                    <xs:attribute name=“name”
type=“xs:string” use=“required” />
                                  </xs:complexType>
                                </xs:element>
                              </xs:sequence>
                            </xs:complexType>
                          </xs:element>
                        </xs:sequence>
                        <xs:attribute name=
                        “StartMenuRegFilePath”
type=“xs:string” use=“required” />
                      </xs:complexType>
                    </xs:element>
                    <xs:element name=“StartScreen”>
                      <xs:complexType>
                        <xs:simpleContent>
                          <xs:extension base=“xs:string”>
                            <xs:attribute name=“LayoutPath”
type=“xs:string” use=“required” />
                            <xs:attribute name=“ShortcutPath”
type=“xs:string” use=“required” />
                          </xs:extension>
                        </xs:simpleContent>
                      </xs:complexType>
                    </xs:element>
                  </xs:sequence>
                </xs:complexType>
              </xs:element>
            </xs:sequence>
          </xs:complexType>
        </xs:element>
      </xs:sequence>
    </xs:complexType>
  </xs:element>
</xs:schema>
```

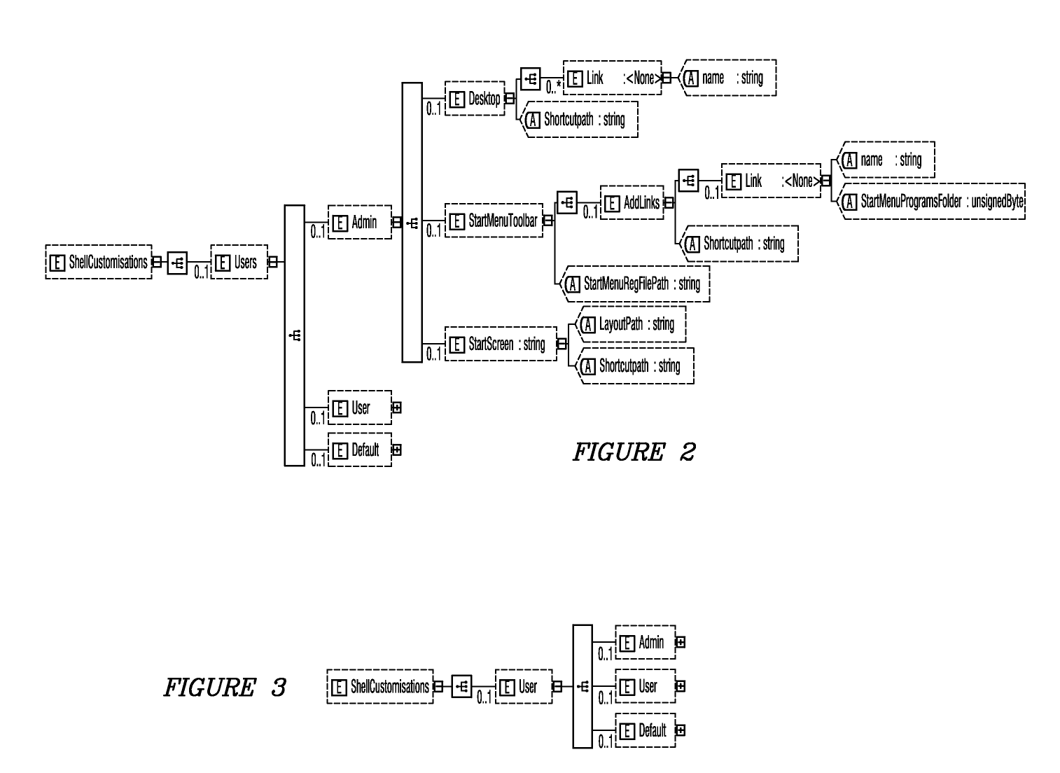

FIG. 2 illustrates a graphical representation of the example XML XSD file above. In particular embodiments, the XML configuration file may specify paths for the files required for configuration customizations. In particular embodiments, files required for configuration customization for every user may be maintained in a folder structure. Paths for the folder structure may be defined in the XML configuration file. Upon execution (e.g., by the configuration application WSC.exe), the XML configuration file may be parsed into paths where files required for configuration customization may be found in the folder structure. For standard configuration described earlier, the XML configuration file and associated files and folders are included with thin clients that are ready to be shipped to customers. For custom configurations described earlier, additional folder structures and files for creating a user profile may be appended to the XML configuration file.

The example XML configuration file may be used on a per user basis. FIG. 3 illustrates a graphical representation of an example XML definition for users. As illustrated in FIG. 3, the XML configuration may be divided into 3 user sections: Admin, User, and Default. The Admin section may apply only to administrator user login. The User section may apply only to user login. “User” is a name of a restricted user that is present in the Standard Builds described earlier. The Default section may apply to any other user login apart from users associated with the Admin and the User sections. In particular embodiments, a new user section may also be added in the XML configuration file and configuration associated with the new user may be performed accordingly.

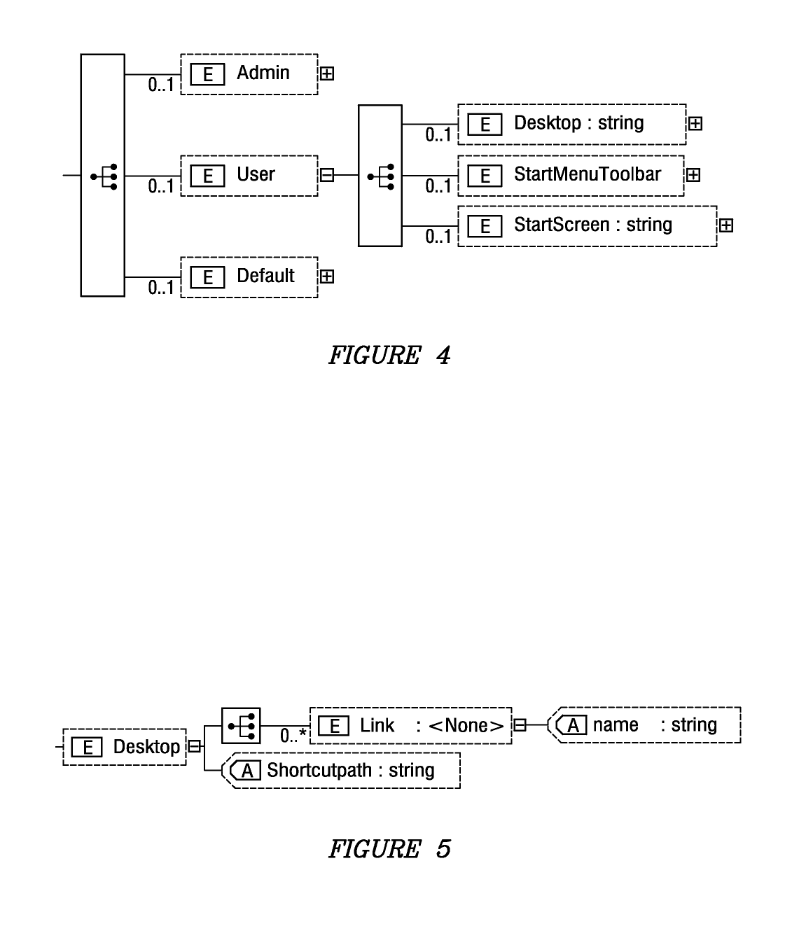

In particular embodiments, each user section in the XML configuration file may have multiple available options or customizations. FIG. 4 illustrates a graphical representation of an example XML definition for user options. As illustrated in the example of FIG. 4, each user section may have three options in Desktop Shortcuts, Start Menu Toolbar, and Start Screen.

In particular embodiments, the Desktop Shortcuts option may enable configurations for the Desktop Shortcuts user interface in a Windows 8 user interface. FIG. 5 illustrates a graphical representation of an example XML definition for desktop shortcuts configuration. In particular embodiments, the Desktop Shortcuts option may comprise all the shortcuts present in a specified folder such that all the shortcuts are copied to the operating system shell's desktop user interface for a user that currently logins into the client device. For example, the following code may copy all the shortcuts present in a folder to the desktop user interface.

<Desktop Shortcutpath =
“C:\Windows\Setup\Profile\Users\Admin\Desktop”>
</Desktop>

In particular embodiments, the Desktop Shortcuts option may comprise one or more specific shortcuts present in a specified folder such that these specific shortcuts are copied to the operating system shell's desktop user interface for a user that currently logins into the client device. In particular embodiments, the user may specify any number of particular shortcuts in the Desktop Shortcuts option. For example, the following code may copy two shortcuts present in a folder to the desktop user interface.

```
<Desktop Shortcutpath =
“C:\Windows\Setup\Profile\Users\Admin\Desktop”>
  <Link name = “Run.lnk”/>
  <Link name = “Search.lnk”/>
</Desktop>
```

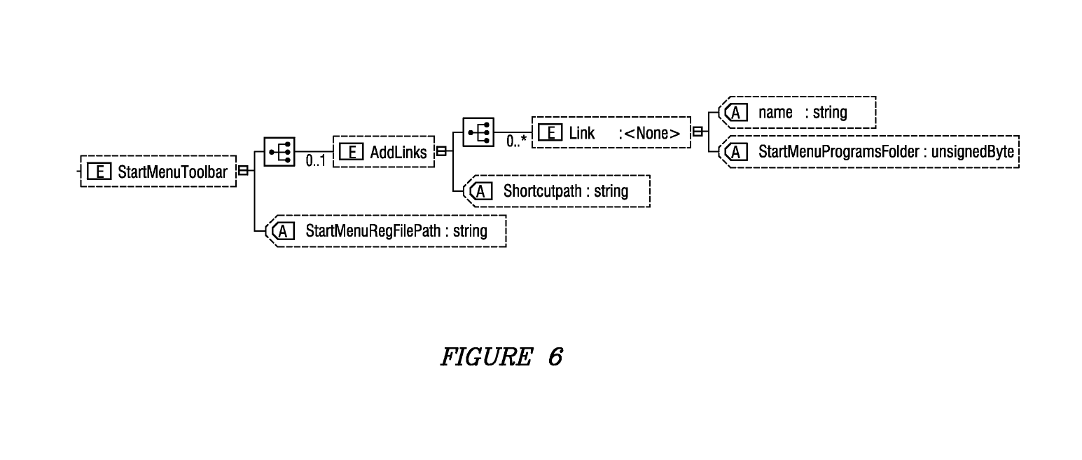

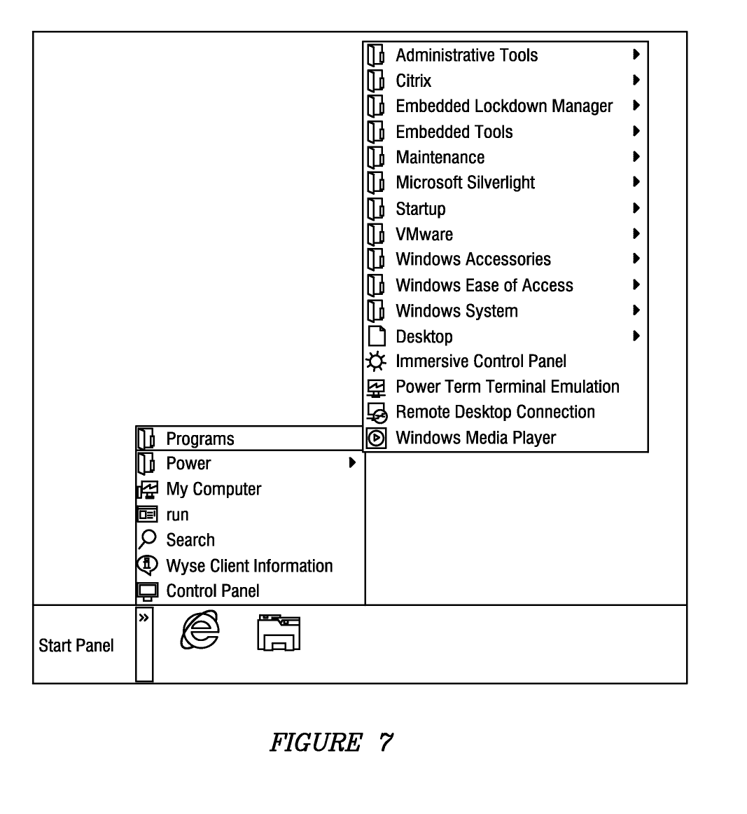

In particular embodiments, the Start Menu Toolbar option may enable configurations for the Start Menu user interface in a Windows 8 user interface. The Start Menu user interface may be accessed from the toolbar section of the Windows 8 user interface. As discussed earlier, the Start Menu Toolbar user interface may allow a user an easier transition from the user interface of Windows 7 (or Windows XP) to the user interface of Windows 8. The Start Menu Toolbar user interface may allow a user to access any installed applications. The Start Menu Toolbar user interface may allow a user to access applications that do not have corresponding tiles in the Windows 8 user interface. FIG. 6 illustrates a graphical representation of an example XML definition for Start Menu Toolbar configuration. FIG. 7 illustrates an example Start Menu Toolbar. In particular embodiments, a user may customize applications accessible from the Start Menu Toolbar user interface with the Start Menu Toolbar option section in the example XML configuration file. Example code of a Start Menu Toolbar option are listed below.

```
<StartMenuToolbar StartMenuRegFilePath = “C:
\StartMenu\RegFile\startmenu.reg”>
    <AddLinks Shortcutpath = “C:\S tartMenu\Layout”>
      <Link name = “Power” StartMenuProgramsFolder = “” />
      <Link name = “Control Panel.lnk” StartMenuProgramsFolder =
“”/> </AddLinks>
    <RemoveLinks>
      <Link name = “programs\System Tools\Command
      Prompt.lnk”/>
      <Link name = “programs\System Tools\Computer.lnk”/>
      <Link name = “programs\System Tools\File Explorer.lnk”/>
      <Link name = “programs\System Tools\Run.lnk”/>
      <Link name = “programs\Accessories\Notepad.lnk”/>
</RemoveLinks>
</StartMenuToolbar>
```

As illustrated by the example codes above, the Start Menu Toolbar option may comprise several attributes. In particular embodiments, StartMenuRegFilePath attributes may comprise a path to registry file that is responsible for creating a default Start Menu Toolbar user interface. For example, the attribute may point to “%appdata%\microsoft\windows\start menu” folder. Ordinarily, registry files are not accessible to users.

In particular embodiments, AddLinks attribute may comprise any number of links (shortcuts) that will be added to the Start Menu Toolbar user interface. There may be one or more AddLinks elements.

In particular embodiments, Shortcutpath attribute may comprise a path to the shortcuts folder for shortcuts that are going to be picked up and placed in the Start Menu Toolbar user interface.

In particular embodiments, Name attribute may comprise names of files or folders that will be added or removed from the Start Menu Toolbar user interface. If the name attribute corresponds to a folder, files in the folder will be copied recursively. There may be one Name attribute per Link Element. But there may be multiple Link Elements.

In particular embodiments, StartMenuProgramsFolder attribute may comprise a relative path to Start Menu folder path of the currently logged-in user,—i.e. “appdata%\microsoft\windows\start menu” may be a folder that specified file or folder may be copied to. For example, in the code below,

```
<AddLinks Shortcutpath = “C:\StartMenu\Layout”>
  <Link name = “Power” StartMenuProgramsFolder = “” />
  <Link name = “Control Panel.lnk” StartMenuProgramsFolder =
“programs”/>
</AddLinks>
```

Power folder may be copied from “c:\StartMenu\Layout” to “%appdata%\microsoft\windows\start menu”. Control Panel.lnk file may be copied from “c:\StartMenu\Layout” to “%appdata%\microsoft\windows\start menu\programs”.

In particular embodiments, RemoveLinks attribute may comprise links that a user wants to remove from the start menu. The base path may be calculated by the configuration application automatically at run time which is “%appdata%\microsoft\windows\start menu”. So the path specified in the XML configuration file may be relative to this path. For example, in the code below:

<RemoveLinks>
<Link name = “programs\System Tools\Command Prompt.lnk”/>
</RemoveLinks>

Command Prompt.lnk may be removed from the path “%appdata%\microsoft\windows\start menu \programs\System Tools\Command Prompt.lnk”.

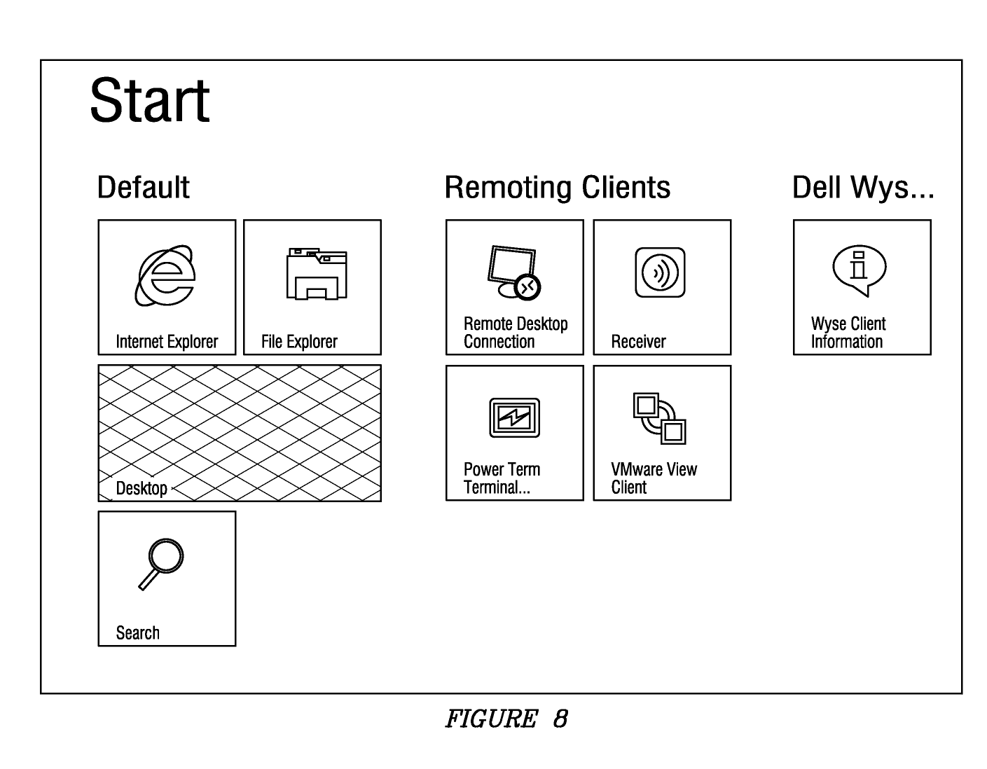

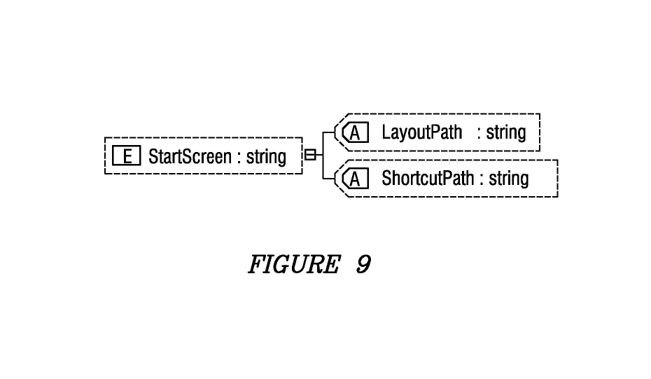

As discussed earlier, a Windows 8 Start Screen user interface may comprise tiles and tile groups. Each tile may correspond to an application. A tile group may comprise tiles corresponding to a set of applications. A tile may also display real-time information (e.g., real-time stock quotes). FIG. 8 illustrates an example Start Screen user interface. A user may create a tile by performing a right click (e.g., with a mouse pointing device) on a shortcut to an application, and select “pin to start” from a context menu. The user may check by pressing windows key that launches the Start Screen user interface. Layout data for tiles may be maintained by the following files: “%localappdata%\microsoft\windows\appsfolder-itemdata-ms” and “%localappdata%\microsoft\windows\appsfolder-itemdata-ms.bak”. Shortcuts that are currently pinned to the Start Menu user interface may in maintained in the folder “%appdata%\microsoft\windows\start menu\programs”. In addition, both Tile Layout and Tile Shortcuts information may be needed to re-create the same layout. FIG. 9 illustrates a graphical representation of an example Start Screen XML configuration. For example, in the code below:

| | |
|---|---|
| StartScreen | |
| LayoutPath | = |
| “C:\Windows\Setup\Profile\Users\Admin\StartScreen\TileLayout” | |
| ShortcutPath | = |
| “C:\Windows\Setup\Profile\Users\Admin\StartScreen\TileShortcuts”> | |
| </StartScreen> | |

LayoutPath attribute may specify a path storing Tile Layout information. ShortcutPath attribute may specify a path storing Tile Shortcuts information. For Standard Builds described earlier, Tile Layout information may be created once and then stored in a folder specified in the XML configuration file.

The configuration application WSC.exe described earlier may be a command line application. WSC.exe may have the following command line options.

WSC.exe -[standard] or [-s]: This option may be used while creating the standard configuration for the Standard Builds described earlier. This option may create three configurations: Start Screen user interface configuration, Start Menu Toolbar user interface configuration, and Desktop Shortcuts user interface configuration based on users specified in the XML configuration file WSCConfig.xml. This option may be executed for every user only once when the user logs into a client device for the first time (e.g., by using Microsoft Windows RunOnce Registry Key). If the user does not exist in the list of users in the XML configuration file, then the Default configuration specified in the XML configuration file may be applied.

WSC.exe [-createprofile] or [-cp]: This option may be used to create user profile for a specified user (e.g., a Local user) based on a current configuration, as described earlier. The user profile creation may include all three configurations above. If a user profile is needed for a domain user, then following optional parameters may be used: WSC.exe -cp USERNAME [DOMAIN] [DOMAIN SERVER]. For example, WSC.exe -cp <user2> citrixtest citrixserver. This may capture a user profile for user <user2> that is hosted on Domain CitrixTest. Thus there may be two user profiles for the user <user2>, a user profile for Local user <user2> and another user profile for Domain user <user2>.

WSC.exe [-custom] or [-c]: This option may perform customizations on an XML configuration file WSCConfig.xml stored in a custom path, instead of an XML configuration file WSCConfig.xml stored in a default path for the -s option above. The operations performed with this option are similar to those performed with the -s option above. The operations performed with option may be customizations that an end user may have explicitly specify by creating a user profile. A custom XML configuration file WSCconfig.xml may be created at runtime by the configuration application WSC.exe.

Standard Configuration for Windows 8 User Interface

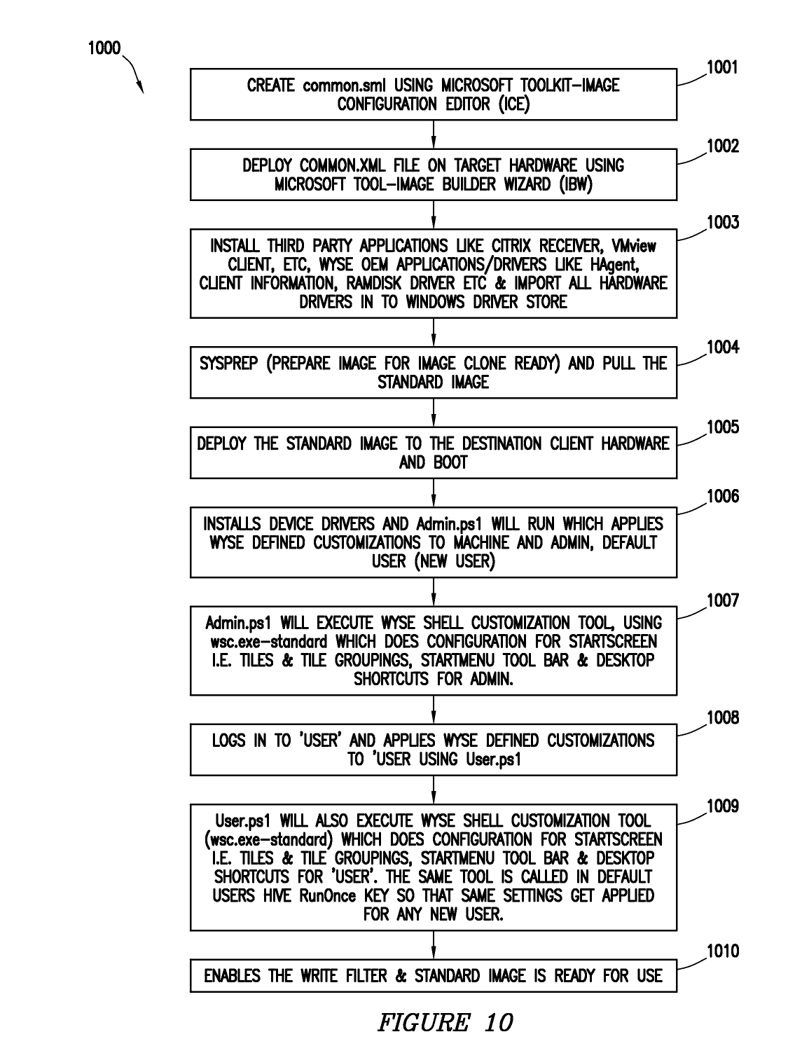

FIG. 10 illustrates an example method 1000 for creating a standard configuration for Standard Builds described earlier. The method 1000 may be implemented by one or more applications. For example, engineers of a vendor of thin clients may create an automation application (e.g., by using a scripting language) and run the automation application to perform steps of the method 1000.

The method 1000 may start at step 1001. At step 1001, particular embodiments may create common.xml using Microsoft Toolkit-Image Configuration Editor (ICE). At step 1002, particular embodiments may deploy common.xml file on target hardware using Microsoft Tool-Image Builder Wizard (IBW). At step 1003, particular embodiments may install Third party Applications like Citrix Receiver, VMview client, etc, Wyse OEM Applications/drivers like HAgent, Client Information, Ramdisk driver etc & Import all Hardware drivers in to windows driver store. At step 1004, particular embodiments may execute Sysprep (Prepare Image for Image clone ready) and pull the Standard image.

At step 1005, particular embodiments may deploy the standard image to the destination client hardware and boot. At step 1006, particular embodiments may install device drivers and Admin.ps1 will run which applies Dell Wyse defined Customizations to machine and Admin, Default User (New User). At step 1007, Admin.ps1 will also execute Windows Shell Customization Tool, using wsc.exe -standard which does configuration for StartScreen i.e tiles & tile groupings, Startmenu Tool bar & Desktop shortcuts for Admin. At step 1008, particular embodiments may log in to ‘User’ and applies Dell Wyse defined Customizations to ‘User using User.ps1. At step 1009, User.ps1 will also execute Windows Shell Customization Tool (wsc.exe -standard) which does configuration for StartScreen i.e tiles & tile groupings, Startmenu Tool bar & Desktop shortcuts for ‘User’. The same tool is called in Default Users Hive RunOnce key so that same settings get applied for any new user. At step 1010, particular embodiments may enables the write filter & Standard Image is ready for use.

Custom Configuration for Windows 8 Operating System Shell

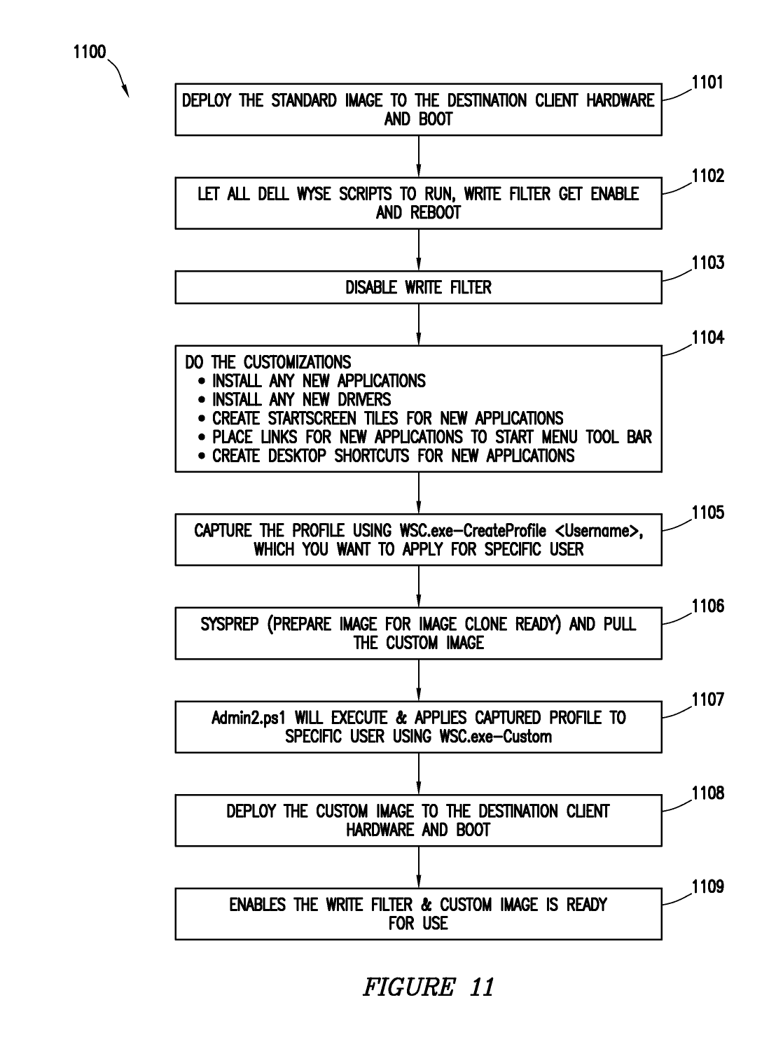

FIG. 11 illustrates an example method 1100 for creating a custom configuration. The custom configuration of the method 1100 may be performed on top of the standard configuration created by the method 1100. The method 1100 may be implemented by one or more applications. For example, engineers of a customer of thin clients may create an automation application (e.g., by using a scripting language) and run the automation application to perform steps of the method 1100 on thin clients received from a vendor.

The method 1100 may start at step 1101. At step 1101, particular embodiments may deploy the standard image (e.g., with the standard configuration created by the method 1000) to the destination client hardware and boot. At step 1102, particular embodiments may let all Dell wyse scripts to run, write filter get enable and reboot. At step 1103, particular embodiments may disable write filter.

At step 1104, particular embodiments may perform customizations such as installing new applications, installing new drivers, creating Start Screen tiles for new applications, placing links to new applications to Start Menu Toolbar, or creating Desktop Shortcuts for new applications. At step 1105, particular embodiments may capture the profile using WSC.exe -CreateProfile <Username> that may apply for specific User. At step 1106, particular embodiments may execute Sysprep (Prepare Image for Image clone ready) and pull the custom image. At step 1107, Admin2.ps1 may execute & apply captured profile to specific user using WSC.exe -Custom. At step 1108, particular embodiments may deploy the custom image to the destination client hardware and boot. At step 1009, particular embodiments may enable the write filter and a custom image is ready for use.

Automatic User-Based XML Code Creation for Custom User Profiles

In particular embodiments, a user may create a custom user profile by capturing configurations of the user's current login session. For example, the user may execute the configuration application with a command: WSC.exe -createprofile <username>. The configuration application may, in response to the user's command, create a user profile and, without further manual input from the user, merge corresponding XML codes to a master configuration file (e.g., WSCconfig.XML). The configuration application may check if the user already exists in the master configuration file. If the user already exists in the master configuration file, the configuration application may update the corresponding user section in the master configuration file with codes for the captured user profile. If the user does not exists in the master configuration file, the configuration application may create a new user section with <username> in the master configuration file including codes for the captured user profile. In this way, no separate XML configuration files are needed for customization by different users.

Custom User Profile Creation for Domain Users

Particular embodiments may create a custom user profile for a domain user. In particular embodiments, a user may execute the configuration application with a command: “WSC.exe -createprofile <username> [Domain] [Domain Server]”—e.g., “WSC.exe -createprofile <user2> CitrixTest.com CitrixServer”. In particular embodiments, the configuration application may, in response to the user's command, check if the user is currently logged into the domain CitrixTest.com. If the user is not currently logged into the domain, the configuration application may return an error to the user. In particular embodiments, the configuration application may create a user profile named “user2.Citrixtest.com”. In particular embodiments, the configuration application may capture configurations in Start Screen, Start Menu Toolbar and Desktop Shortcuts user interfaces. In particular embodiments, the configuration application may add a user section in XML codes with the name “user2.Citrixtest.com”. In particular embodiments, the configuration application may append other configuration entries for this user under this user section. In particular embodiments, the configuration application may append the XML codes for the user section created during run-time to a master XML configuration file.

Security Verification for Local User

Particular embodiments may verify security settings for a local user. In particular embodiments, a user may execute the configuration application with a command: “WSC.exe -createprofile <username>”—e.g., “WSC.exe -createprofile <user2>”. In particular embodiments, the configuration application may, in response to the user's command, verify if a currently logged-in user belongs to Administrators Group. In particular embodiments, the configuration application may verify if the user requesting to create a user profile belongs to Administrators Group. In particular embodiments, the configuration application may verify if a user profile may be created based on the following rules:

(a) If the logged-in user belongs to Administrators Group and the user requesting a user profile also belongs Administrators group, then profile creation is allowed.

(b) If the logged-in user belongs to Administrators Group and the user requesting a user profile belongs to a non-administrator Group, then profile creation is not allowed and vice versa.

(c) If the logged-in user belongs to non-Administrators Group and the user requesting a user profile also belongs a non-administrator group, then profile creation is allowed.

In particular embodiments, the configuration application may create the user profile for the user <user2> by capturing configurations in Start Screen, Start Menu Toolbar and Desktop Shortcuts user interfaces. In particular embodiments, the configuration application may add a user section in XML codes with the name “user2”. In particular embodiments, the configuration application may append other configuration entries for this user under this user section. In particular embodiments, the configuration application may append the XML codes for the user section created during run-time to a master XML configuration file.

Security Verification for Domain User

Particular embodiments may verify security settings for a domain user. In particular embodiments, a user may execute the configuration application with a command: “WSC.exe -createprofile <username> [Domain] [Domain Server]”—e.g., “WSC.exe -createprofile <user2> CitrixTest.com CitrixServer”. In particular embodiments, the configuration application may, in response to the user's command, verify if the user is currently logged into Domain CitrixTest.com. If not, the configuration application may return an error to the user. In particular embodiments, the configuration application may verify if a currently logged-in user belongs to Administrators Group. In particular embodiments, the configuration application may verify if the user requesting a user profile belongs to Administrators Group. In particular embodiments, the configuration application may verify if a user profile may be created based on the following rules:

(a) If the logged-in user belongs to Administrators Group and the user requesting a user profile also belongs Administrators group, then profile creation is allowed.

(b) If the logged-in user belongs to Administrators Group and the user requesting a user profile belongs to a non-administrator group, then profile creation is not allowed and vice versa.

(c) If the logged-in user belongs to a non-Administrator Group and the user requesting a user profile also belongs to a non-Administrator group, then profile creation is allowed.

In particular embodiments, the configuration application may create a user profile named “user2.Citrixtest.com”. In particular embodiments, the configuration application may create the user profile by capturing configurations in Start Screen, Start Menu Toolbar and Desktop Shortcuts user interfaces. In particular embodiments, the configuration application may add a user section in XML codes with the name “user2.Citrixtest.com”. In particular embodiments, the configuration application may append other configuration entries for this user under this user section. In particular embodiments, the configuration application may append the XML codes for the user section created during run-time to a master XML configuration file.

Creating Localization During Standard Configuration

Particular embodiments may create localization while performing the standard configuration described earlier. In particular embodiments, a user may execute on a client device the configuration application with a command: “WSC.exe -standard”. In particular embodiments, the configuration application may, in response to the user's command, determine a current localization set on the client device. In particular embodiments, the configuration application may determine if the current localization belongs to a list of localizations supported (the list may be updated based on business needs). If the current localization belongs to the list of supported localizations, the configuration application may apply localized versions of Tile Layout and Tile Shortcuts information to the standard configuration. If the current localization does not belong to the list of supported localizations, the configuration application may apply a default versions (e.g., en-US) of Tile Layout and Tile Shortcuts information to the standard configuration.

Creating Localization during Custom Configuration

Particular embodiments may create localization while performing custom configuration described earlier. In particular embodiments, a user may execute on a client device the configuration application with a command: “WSC.exe -createprofile user2”. In particular embodiments, the configuration application may, in response to the user's command, determine a current localization set on the client device. In particular embodiments, the configuration application may determine if the current localization belongs to a list of localizations supported (the list may be updated based on business needs). If the current localization belongs to the list of supported localizations, the configuration application may create a folder storing localized versions of Tile Layout and Tile Shortcuts information. The configuration application may add a path corresponding to the folder to XML codes being created during custom configuration. As part of the custom configuration, the configuration application may add the XML codes including the path to a final master XML configuration file.

Remote Deployment to Multiple Thin Clients with Wyse Configuration Manager (WCM)

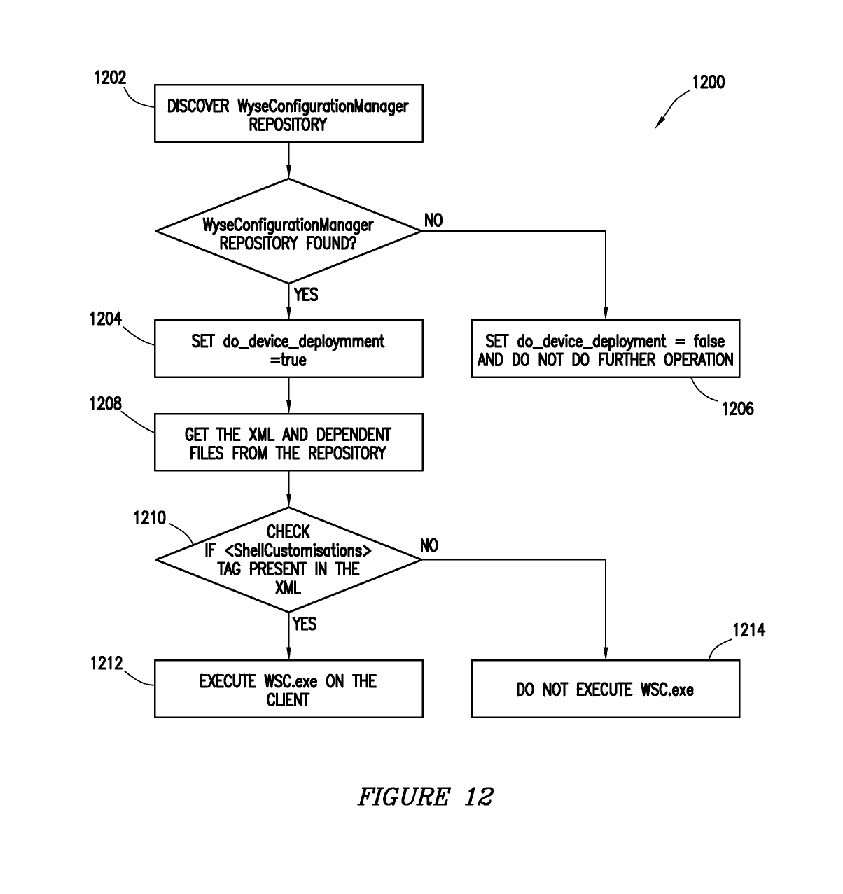

Particular embodiments may configure a client device such as a thin client by deploying a configuration file to the client device. FIG. 12 illustrates an example method 1200 for configuring a client device. The method 1200 may be implemented by a computing process (e.g., a WCM Agent) executed by one or more processors of the client device.

The method 1200 may start at step 1202. In particular embodiments, a WCM Agent running on a thin client may look for a WyseConfigurationManager repository (e.g., a server). In particular embodiments, at step 1204, the WCM Agent may set auto deployment to be true if the repository is found. The WCM Agent may set auto deployment to be false if the repository is not found (step 1206). In particular embodiments, at step 1208, the WCM Agent may retrieve the required Configuration XML and the dependent files from the repository.

In particular embodiments, at step 1210, the WCM Agent may look for the tag <Shellcustomisations> in the XML configuration file. In particular embodiments, at step 1212, if the tag <Shellcustomisations> is found, the WCM Agent may execute WSC.exe -custom command on the client. The configuration application WCS.exe may perform the required custom configuration as specified in the XML configuration file. At step 1214, the WCM Agent may not execute WSC.exe if the tag <Shellcustomisations> is not found.

Remote Deployment to Multiple Thin Clients with Wyse Device Manager (WDM)

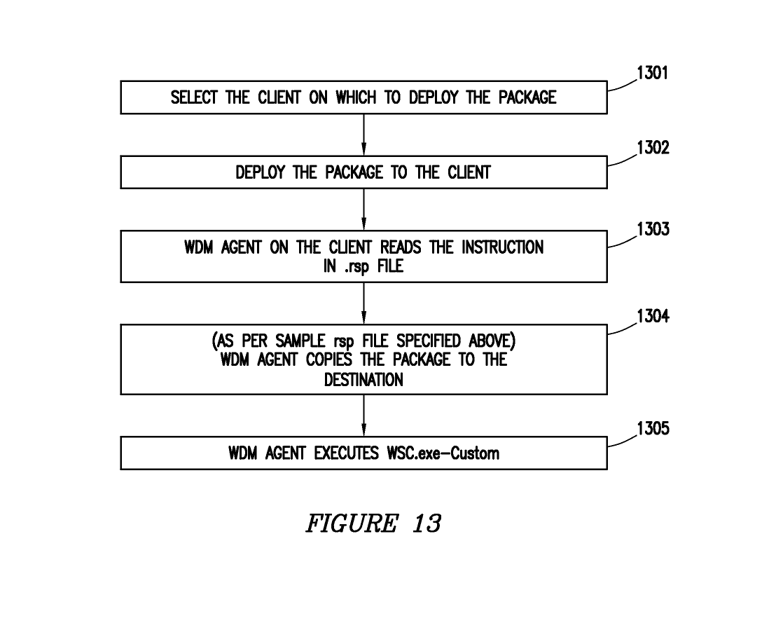

Particular embodiments may configure a client device such as a thin client by deploying a configuration file and a script file to the client device. Particular embodiments may create a configuration package comprising the configuration application WSC.exe, an XML configuration file, and dependent files. The package may also be associated with a script file (.rsp file) that contains instructions for a WDM Agent. FIG. 13 illustrates an example method 1300 for configuring a client device.

The method 1300 may start at step 1301. In particular embodiments, at step 1301, a user (e.g., an administrator) or an automated computing process may select a client device to deploy the configuration package. In particular embodiments, at step 1302, the user may send the package and associated .rsp file to the selected client device. In particular embodiments, at step 1303, a computing process (e.g., WDM Agent) running on the client device may access the .rsp file for instructions. In particular embodiments, at step 1304, the computing process may copy content of the package to a destination as specified by the .rsp file. In particular embodiments, at step 1305, the computing process may execute the configuration application with a command “WCS.exe -custom” to configure the client device.

An example .rsp script file is listed below.

Version]
Number=WE8S_WSC
Description=WSC Package
OS=WE8S
Category=Other Packages
USE_Pxe=NO
[Script]
;---------------------------------------------------
; Check Operating System
;---------------------------------------------------
LU
CO “WE8S”
;---------------------------------------------------
; Copy over new files
;---------------------------------------------------
XC “<regroot>\Temp\” “C:\Widnows\setup”
EX “c:\windows\setup\profile\wsc.exe -custom”
EL

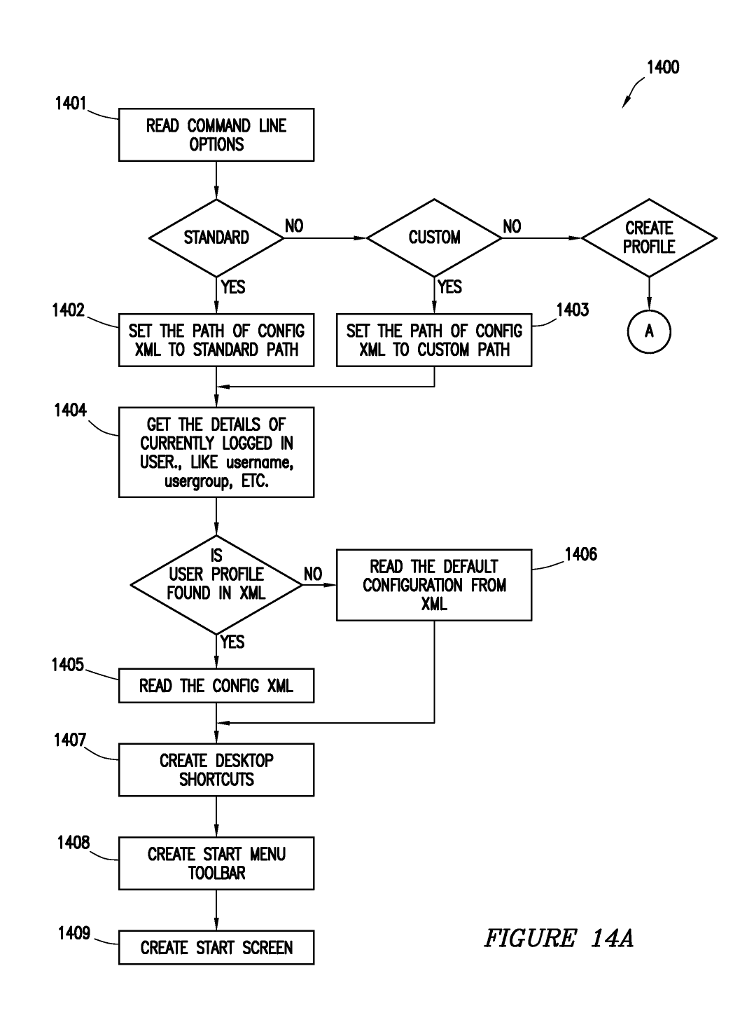

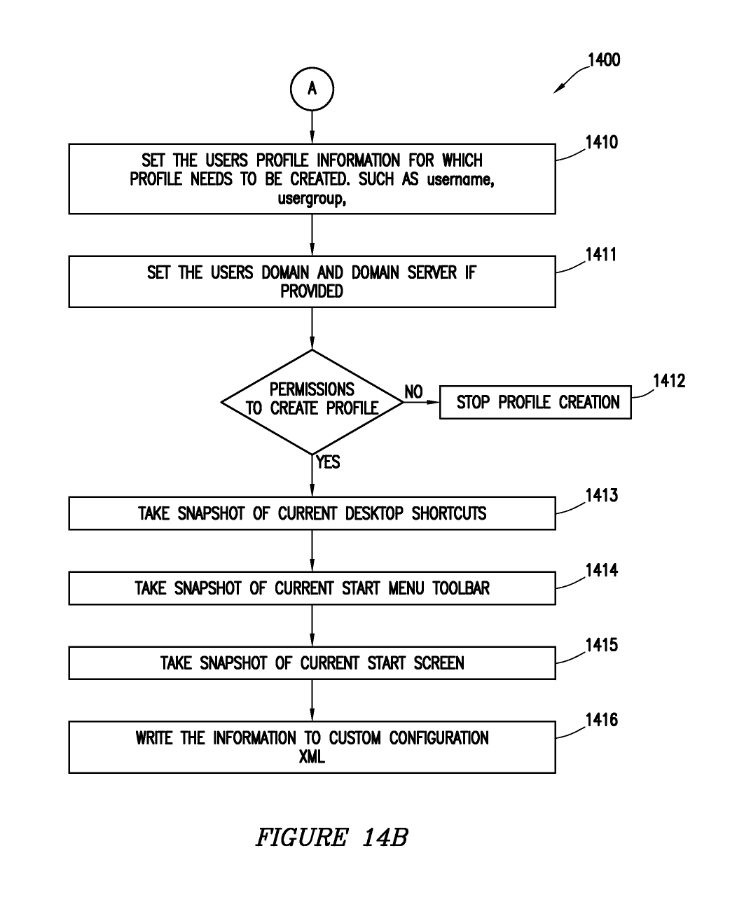

FIGS. 14A and 14B illustrate an example flow chart 1400 of a configuration application such as WSC.exe described earlier. The flow 1400 may start at step 1401. In particular embodiments, at step 1401, the configuration application running on a client device may read command line options (e.g., as specified by a user or by a script file). In particular embodiments, at step 1402, if the command line specifies a standard configuration, the configuration application may set a path for an XML configuration file to a standard path. In particular embodiments, at step 1403, if the command line specifies a custom configuration, the configuration application may set a path for the XML configuration file to a custom path. In particular embodiments, at step 1404, the configuration application may get details of a currently logged-in user (e.g., a user name, a user group, and so on). In particular embodiments, at step 1405, if a user profile exists in the XML configuration file, the configuration application may read configuration settings from the XML configuration file based on the user profile. In particular embodiments, at step 1406, if a user profile does not exist in the XML configuration file, the configuration application may read default configuration settings from the XML configuration file. In particular embodiments, at step 1407, the configuration application may create a Desktop Shortcuts user interface in a Windows 8 user interface based on configuration settings in the XML configuration file. In particular embodiments, at step 1408, the configuration application may create a Start Menu Toolbar user interface in the Windows 8 user interface based on configuration settings in the XML configuration file. In particular embodiments, at step 1409, the configuration application may create a Start Screen user interface in the Windows 8 user interface based on configuration settings in the XML configuration file.

In particular embodiments, at step 1410, if the command line specifies a user profile, the configuration application may set user profile information needed to create a user profile (e.g., a user name, a user group). In particular embodiments, at step 1411, the configuration application may set a user domain and a domain server if such information is provided. In particular embodiments, at step 1412, the configuration application may stop creating a user profile if the configuration application does not the permission in creating a user profile. In particular embodiments, at step 1413, the configuration application may take a snapshot of the current Desktop Shortcuts user interface in the operating system shell. In particular embodiments, at step 1414, the configuration application may take a snapshot of the current Start Menu Toolbar user interface in the operating system shell. In particular embodiments, at step 1415, the configuration application may take a snapshot of the current Start Screen user interface in the operating system shell. In particular embodiments, at step 1416, the configuration application may write the information from the snapshots to a custom configuration XML file.

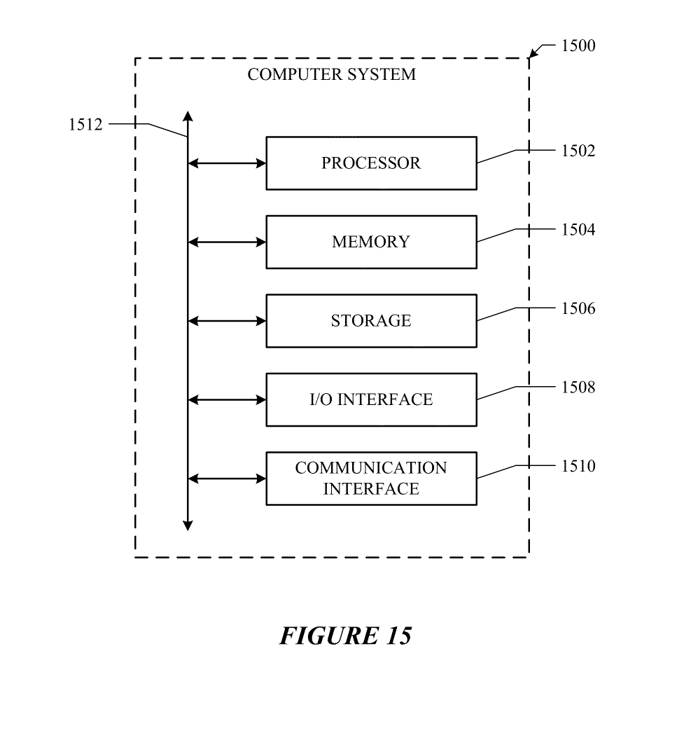

Particular embodiments may be implemented on one or more electronic devices or computer systems. FIG. 15 illustrates an example information handling system, computer system 1500. For example, computer system 1500 may be an embodiment for a device that runs a UI content editor. In particular embodiments, one or more computer systems 1500 perform one or more steps of one or more methods described or illustrated herein. In particular embodiments, one or more computer systems 1500 provide functionality described or illustrated herein. In particular embodiments, software running on one or more computer systems 1500 performs one or more steps of one or more methods described or illustrated herein or provides functionality described or illustrated herein. Particular embodiments include one or more portions of one or more computer systems 1500.

This disclosure contemplates any suitable number of computer systems 1500. This disclosure contemplates computer system 1500 taking any suitable physical form. As example and not by way of limitation, computer system 1500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 1500 may include one or more computer systems 1500; be unitary or distributed; span multiple locations; span multiple machines; or reside in a cloud, which may include one or more cloud components in one or more networks. Where appropriate, one or more computer systems 1500 may perform without substantial spatial or temporal limitation one or more steps of one or more methods described or illustrated herein. As an example and not by way of limitation, one or more computer systems 1500 may perform in real time or in batch mode one or more steps of one or more methods described or illustrated herein. One or more computer systems 1500 may perform at different times or at different locations one or more steps of one or more methods described or illustrated herein, where appropriate.

In particular embodiments, computer system 1500 includes a processor 1502, memory 1504, storage 1506, an input/output (I/O) interface 1508, a communication interface 1510, and a bus 1512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1502 includes hardware for executing instructions, such as those making up a computer program. As an example and not by way of limitation, to execute instructions, processor 1502 may retrieve (or fetch) the instructions from an internal register, an internal cache, memory 1504, or storage 1506; decode and execute them; and then write one or more results to an internal register, an internal cache, memory 1504, or storage 1506. In particular embodiments, processor 1502 may include one or more internal caches for data, instructions, or addresses. This disclosure contemplates processor 1502 including any suitable number of any suitable internal caches, where appropriate. As an example and not by way of limitation, processor 1502 may include one or more instruction caches, one or more data caches, and one or more translation lookaside buffers (TLBs). Instructions in the instruction caches may be copies of instructions in memory 1504 or storage 1506, and the instruction caches may speed up retrieval of those instructions by processor 1502. Data in the data caches may be copies of data in memory 1504 or storage 1506 for instructions executing at processor 1502 to operate on; the results of previous instructions executed at processor 1502 for access by subsequent instructions executing at processor 1502 or for writing to memory 1504 or storage 1506; or other suitable data. The data caches may speed up read or write operations by processor 1502. The TLBs may speed up virtual-address translation for processor 1502. In particular embodiments, processor 1502 may include one or more internal registers for data, instructions, or addresses. This disclosure contemplates processor 1502 including any suitable number of any suitable internal registers, where appropriate. Where appropriate, processor 1502 may include one or more arithmetic logic units (ALUs); be a multi-core processor; or include one or more processors 1502. Although this disclosure describes and illustrates a particular processor, this disclosure contemplates any suitable processor.

In particular embodiments, memory 1504 includes main memory for storing instructions for processor 1502 to execute or data for processor 1502 to operate on. As an example and not by way of limitation, computer system 1500 may load instructions from storage 1506 or another source (such as, for example, another computer system 1500) to memory 1504. Processor 1502 may then load the instructions from memory 1504 to an internal register or internal cache. To execute the instructions, processor 1502 may retrieve the instructions from the internal register or internal cache and decode them. During or after execution of the instructions, processor 1502 may write one or more results (which may be intermediate or final results) to the internal register or internal cache. Processor 1502 may then write one or more of those results to memory 1504. In particular embodiments, processor 1502 executes only instructions in one or more internal registers or internal caches or in memory 1504 (as opposed to storage 1506 or elsewhere) and operates only on data in one or more internal registers or internal caches or in memory 1504 (as opposed to storage 1506 or elsewhere). One or more memory buses (which may each include an address bus and a data bus) may couple processor 1502 to memory 1504. Bus 1512 may include one or more memory buses, as described below. In particular embodiments, one or more memory management units (MMUs) reside between processor 1502 and memory 1504 and facilitate accesses to memory 1504 requested by processor 1502. In particular embodiments, memory 1504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1504 may include one or more memories 1504, where appropriate. Although this disclosure describes and illustrates particular memory, this disclosure contemplates any suitable memory.

In particular embodiments, storage 1506 includes mass storage for data or instructions. As an example and not by way of limitation, storage 1506 may include an HDD, a floppy disk drive, flash memory, an optical disc, a magneto-optical disc, magnetic tape, or a Universal Serial Bus (USB) drive or a combination of two or more of these. Storage 1506 may include removable or non-removable (or fixed) media, where appropriate. Storage 1506 may be internal or external to computer system 1500, where appropriate. In particular embodiments, storage 1506 is non-volatile, solid-state memory. In particular embodiments, storage 1506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1506 taking any suitable physical form. Storage 1506 may include one or more storage control units facilitating communication between processor 1502 and storage 1506, where appropriate. Where appropriate, storage 1506 may include one or more storages 1506. Although this disclosure describes and illustrates particular storage, this disclosure contemplates any suitable storage.

In particular embodiments, I/O interface 1508 includes hardware, software, or both providing one or more interfaces for communication between computer system 1500 and one or more I/O devices. Computer system 1500 may include one or more of these I/O devices, where appropriate. One or more of these I/O devices may enable communication between a person and computer system 1500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1508 for them. Where appropriate, I/O interface 1508 may include one or more device or software drivers enabling processor 1502 to drive one or more of these I/O devices. I/O interface 1508 may include one or more I/O interfaces 1508, where appropriate. Although this disclosure describes and illustrates a particular I/O interface, this disclosure contemplates any suitable I/O interface.

In particular embodiments, communication interface 1510 includes hardware, software, or both providing one or more interfaces for communication (such as, for example, packet-based communication) between computer system 1500 and one or more other computer systems 1500 or one or more networks. As an example and not by way of limitation, communication interface 1510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1510 for it. As an example and not by way of limitation, computer system 1500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1500 may include any suitable communication interface 1510 for any of these networks, where appropriate. Communication interface 1510 may include one or more communication interfaces 1510, where appropriate. Although this disclosure describes and illustrates a particular communication interface, this disclosure contemplates any suitable communication interface.

In particular embodiments, bus 1512 includes hardware, software, or both coupling components of computer system 1500 to each other. As an example and not by way of limitation, bus 1512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1512 may include one or more buses 1512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The concepts disclosed in this application should not be understood to be limited to the exemplary embodiments described herein, but should be understood to encompass all changes, substitutions, variations, alterations, and modifications to the example embodiments herein that a person having ordinary skill in the art would comprehend. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
receiving, at a computing device, one or more command-line options;
determining a user associated with the computing device;
accessing, based on the command-line options and the user, a configuration file for configuration settings for one or more user interfaces within an operating system shell hosted by the computing device, each of the user interfaces comprising one or more elements for accessing one or more applications installed on the computing device; and
creating the user interfaces within the operating system shell based on the configuration settings.

2. The method of claim 1, wherein the accessing, based on the command-line options and the user, configuration file for configuration settings is further based on a user profile associated with the user.

3. The method of claim 1, further comprising creating a user profile.

4. The method of claim 3, wherein:
the user currently logs into the computing device; and
the creating a user profile is based on one or more access permission settings associated with the user.

5. The method of claim 3, where the creating a user profile comprises creating a domain user profile.

6. The method of claim 1, wherein the creating the user interfaces within the operating system shell is further based on a localization setting.

7. The method of claim 1, wherein:
a command-line option is an option for creating a standard configuration, an option for creating a custom configuration, or an option for creating a user profile.

8. The method of claim 1, wherein:
the operating system shell is a user interface of Microsoft Windows 8 operating system; and
the user interface is a desktop shortcuts user interface, a start menu toolbar user interface, or a start screen user interface.

9. The method of claim 1, further comprising:
receiving, from a remote server, the configuration file.

10. The method of claim 1, wherein the command-line options are received from a remote server.

11. A system comprising:
one or more processors; and
a memory coupled to the processors comprising instructions executable by the processors, the processors being operable when executing the instructions to:
receive one or more command-line options;
determine a user associated with the system;
access, based on the command-line options and the user, a configuration file for configuration settings for one or more user interfaces within an operating system shell hosted by the system, each of the user interfaces comprising one or more elements for accessing one or more applications installed on the system; and
create the user interfaces within the operating system shell based on the configuration settings.

12. The system of claim 11, wherein the accessing, based on the command-line options and the user, configuration file for configuration settings is further based on a user profile associated with the user.

13. The system of claim 11, wherein the processors are further operable when executing the instructions to create a user profile.

14. The system of claim 13, wherein:
the user currently logs into the computing device; and
the creating a user profile is based on one or more access permission settings associated with the user.

15. The system of claim 13, where to create a user profile, the processors are operable when executing the instructions to create a domain user profile.

16. The system of claim 11, wherein the creating the user interfaces within the operating system shell is further based on a localization setting.

17. The system of claim 11, wherein:
a command-line option is an option for creating a standard configuration, an option for creating a custom configuration, or an option for creating a user profile.

18. The system of claim 11, wherein:
the operating system shell is a user interface of Microsoft Windows 8 operating system; and
the user interface is a desktop shortcuts user interface, a start menu toolbar user interface, or a start screen user interface.

19. The system of claim 11, wherein the processors are further operable when executing the instructions to:
receive, from a remote server, the configuration file.

20. The system of claim 11, wherein the command-line options are received from a remote server.
